(19) United States
(12) Patent Application Publication
(10) Pub. No.: US 2018/0126386 A1
(43) Pub. Date: May 10, 2018

(54) MULTI-SECTION HERB GRINDER

(71) Applicant: Urb Grider Company, LLC, Woodbridge, VA (US)

(72) Inventors: Ryan J. WITKO, Reston, VA (US); Shayan ORAEE, McLean, VA (US)

(21) Appl. No.: 15/801,593

(22) Filed: Nov. 2, 2017

Related U.S. Application Data
(60) Provisional application No. 62/419,073, filed on Nov. 8, 2016.

(51) Int. Cl. B02C 18/08

(52) U.S. Cl. CPC B02C 18/08; A47J 42/24

(57) ABSTRACT

A multi-section grinder includes a grinder section, a filter section, and a collection section. The filter section has a photo-etched stainless steel filter including a stainless steel sheet, a plurality of photo-etched apertures defining openings through the stainless steel sheet, and opposing tabs extending from a periphery of the stainless steel sheet. The grinder section, the filter section, and the collection section are releasably connected to each other with a non-rotating magnetic coupling. Each coupling has a first non-circular peripheral wall on a first section including a first plurality of peripheral magnetic elements and a second non-circular peripheral wall on a second section defining a non-circular peripheral recess. The non-circular peripheral recess is dimensioned to receive the first non-circular peripheral wall and includes a second plurality of peripheral magnetic elements positioned in correspondence with the first plurality of peripheral magnetic elements to magnetically couple the first and second sections.

### CROSS REFERENCE TO RELATED APPLICATION

This application claims priority from and the benefit of Provisional Application No. 62/419,073, filed on Nov. 8, 2016, which is hereby incorporated by reference for all purposes as if fully set forth herein.

### BACKGROUND

### Field

Exemplary embodiments of the present invention relate to a multi-section herb grinder using magnetic couplings and a photo-etched filter element, a magnetic coupling useful for a multi-section herb grinder, and a photo-etched filter element useful for a multi-section herb grinder.

### Discussion of the Background

An herb grinder is a mechanical device for pulverizing dried herbs, spices, tobacco, and other dried plants into particulates. Grinding the herb into particulates allows for the herb to be used in cooking or for the herb to be more readily smoked. Herb grinders can be either manual or electronic. Electronic grinders are typically driven by a motor, which can generate heat and potentially damage the herb. Electronic grinders are also expensive. For grinding a small quantity of herbs, a manual grinder can achieve a similar result to an electric grinder with minimal effort at a lower cost. An early example of a mechanical grinder is U.S. Pat. No. 795,746

Manual grinders typically have two pieces with cooperating cylindrical-shaped pegs or pyramidal shaped pegs that pulverize the herb when the pieces are moved relative to one another. See, e.g., U.S. Pat. No. 8,393,563. The use of pyramidal-shaped pegs to grind herbs is problematic because the tips can break off and get mixed within the herbal mixture. This can be potentially dangerous if the grinder is made of a plastic polymer because smoking plastics could create serious health consequences for the smoker. Grinders that employ the use of cylindrical pegs are also problematic because the cylindrical pegs do not completely grind the herb. With a cylindrical peg based grinder, either a user will have to exert additional effort to grind the herb or the user will have to be content with an incompletely ground product. To address such problems, grinders with arced cutters have been developed, such as U.S. Pat. No. 9,241,597.

Other problems arise in connection with manual grinders that use multiple sections and parts. For example, sections in U.S. Pat. No. 8,393,563 are joined by threaded couplings that may be difficult to use, and elements such as the permanently attached mesh screen may become damaged and impossible to replace. Similarly, sections in U.S. Pat. No. 9,241,597 are joined by threaded locking mechanisms that use a bayonet-type connection. While slightly easier to operate than a normal threaded joint, an issue with both of these connections is that left-handed operation (or operation in a direction loosening the threads) will tend to disassemble the device, and right-handed operation (or operation in a direction tightening the threads) will over-tighten the connections, making it more difficult to disassemble. Further, while the pollen screen assembly is detachable in U.S. Pat. No. 9,241,597, it involves the use of metal or cloth mesh that lacks dimensional stability and long-term durability.

The above information disclosed in this Background section is only for enhancement of understanding of the background of the inventive concepts, and, therefore, it may contain information that does not form the prior art that is already known in this country to a person of ordinary skill in the art.

### SUMMARY

Exemplary embodiments provide a multi-section grinder for herbs and the like that is easy to assemble and disassemble due to the use of non-rotating magnetic couplings.

Exemplary embodiments also provide a photo-etched stainless steel grinder screen that has high dimensional stability and long-term durability.

Additional aspects will be set forth in part in the description which follows and, in part, will be apparent from the disclosure, or may be learned by practice of the inventive concepts.

An exemplary embodiment discloses a multi-section grinder including a grinder section, a filter section, and a collection section. The filter section includes an open top end, a photo-etched stainless steel filter including a stainless steel sheet, a plurality of photo-etched apertures defining openings through the stainless steel sheet, and opposing tabs extending from a periphery of the stainless steel sheet, and an open bottom end. The collection section includes an open top end and a closed bottom end defining a collection bowl. Each of the lower section, the filter section, and the collection section are releasably connected to each other with a non-rotating magnetic coupling. Each non-rotating magnetic coupling includes a first non-circular peripheral wall on a first section including a first plurality of peripheral magnetic elements; and a second non-circular peripheral wall on a second section defining a non-circular peripheral recess, wherein the non-circular peripheral recess is dimensioned to receive the first non-circular peripheral wall and includes a second plurality of peripheral magnetic elements positioned in correspondence with the first plurality of peripheral magnetic elements to magnetically couple the first and second sections when adjacently positioned. In use, the first and second non-circular peripheral walls prevent relative rotation between the first and second sections.

An exemplary embodiment also discloses a non-rotating magnetic coupling for coupling open ends of first and second sections of a generally tubular device including a first non-circular peripheral wall on the first section including a first plurality of peripheral magnetic elements; and a second non-circular peripheral wall on the second section defining a non-circular peripheral recess. The non-circular peripheral recess is dimensioned to receive the first non-circular peripheral wall and includes a second plurality of peripheral magnetic elements positioned in correspondence with the first plurality of peripheral magnetic elements to magnetically couple the first and second sections when adjacently positioned. In use, the first and second non-circular peripheral walls prevent relative rotation between the first and second sections.

An exemplary embodiment further discloses a photo-etched stainless steel filter including a stainless steel sheet, a plurality of photo-etched apertures defining openings through the stainless steel sheet, and opposing tabs extending from a periphery of the stainless steel sheet.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concepts and are incorporated in and constitute a part of this specification, illustrate exemplary embodiments of the inventive concepts, and, together with the description, serve to explain principles of the inventive concepts.

FIG. 1 is a perspective view showing a multi-section herb grinder according to an exemplary embodiment.

FIG. 2 is an exploded view showing the multi-section herb grinder according to an exemplary embodiment.

FIG. 3 is a plan view from below of an upper section of a grinder section according to an exemplary embodiment.

FIG. 4 is a plan view from above of a lower section of a grinder section according to an exemplary embodiment.

FIG. 5 is a plan view from below of a lower section of a grinder section according to an exemplary embodiment.

FIG. 6 is a perspective view of a filter element according to an exemplary embodiment.

FIG. 7 is a plan view from above of a filter section according to an exemplary embodiment.

FIG. 8 is a cross sectional view of a filter section according to an exemplary embodiment.

FIG. 9 is a plan view from below of a filter section according to an exemplary embodiment.

FIG. 10 is a plan view from above of a collection section according to an exemplary embodiment.

FIG. 11 is a cross sectional view of a collection section according to an exemplary embodiment.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements.

Unless otherwise specified, the illustrated exemplary embodiments are to be understood as providing exemplary features of varying detail of various exemplary embodiments. Therefore, unless otherwise specified, the features, components, modules, layers, films, panels, regions, and/or aspects of the various illustrations may be otherwise combined, separated, interchanged, and/or rearranged without departing from the disclosed exemplary embodiments. Further, in the accompanying figures, the size and relative sizes of layers, films, panels, regions, etc., may be exaggerated for clarity and descriptive purposes. When an exemplary embodiment may be implemented differently, a specific process order may be performed differently from the described order. For example, two consecutively described processes may be performed substantially at the same time or performed in an order opposite to the described order. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. Further, the x-axis, the y-axis, and the z-axis are not limited to three axes of a rectangular coordinate system, and may be interpreted in a broader sense. For example, the x-axis, the y-axis, and the z-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Various exemplary embodiments are described herein with reference to sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing. As such, the regions illustrated in the drawings are schematic in nature and their shapes are not intended to illustrate the actual shape of a region of a device and are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

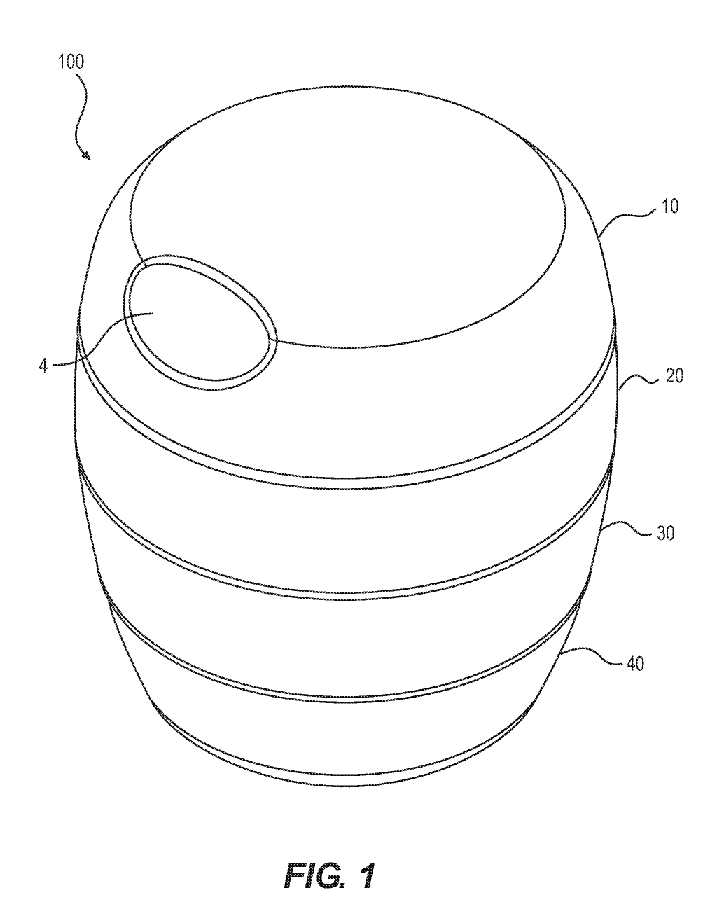

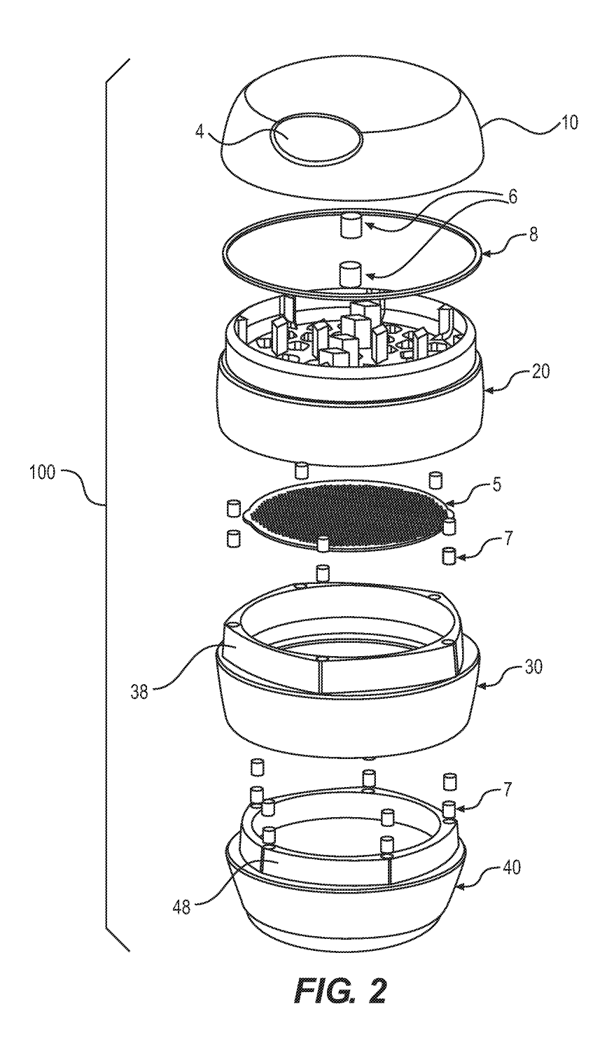

FIG. 1 is a perspective view showing multi-section herb grinder 100 according to an exemplary embodiment, and FIG. 2 is an exploded view showing the multi-section herb grinder 100 according to an exemplary embodiment. Herb grinder 100 may include multiple sections 10, 20, 30, and 40 made of various suitable materials, such as aluminum, steel, glass, wood, plastic, ceramic, or combinations thereof. In one exemplary embodiment, the sections may be formed of 6061 aluminum. In another exemplary embodiment, upper sections may be formed of 6061 aluminum and the lowermost collection section 40 may be formed of glass. In such an embodiment, the filter section 30 may be omitted and the size of the collection section 40 may be expanded.

Herb grinder 100 includes a grinder section made up of upper section 10 and lower section 20. The upper section 10 is configured to rotate relative to lower section 20 and may include a flat portion 4 or other ornamental or shaped elements to aid in gripping and rotation of upper section 10, although such elements are optional. A friction reducing ring 8 may be positioned on one of the adjoining portions of upper section 10 or lower section 20 to reduce wear and ease operation of the grinder section. Any suitable friction-reducing material may be used for ring 8, including but not limited to polytetrafluoroethylene (PTFE, Teflon®), polycarbonate, nylon, ultra high molecular weight polyethylene (UHMWPE), phenolics, and acetal (Delrin®).

Each of upper section 10 and lower section 20 may include an axially positioned magnetic element 6. In one exemplary embodiment, each magnetic element 6 may be, but is not limited to, a 3/16″ dia.× 3/16″ thick neodymium N52 magnet. In another exemplary embodiment, one magnetic element 6 may be a magnet, and the other magnetic element 6 may be a ferrous material that is attracted to magnets. While the use of rare-earth magnets is disclosed, other magnets such as weaker ferrite and alnico magnets may also be used when designed with sufficient surface area. Though use of the axially positioned magnetic elements 6, the upper section 10 and lower section 20 of the grinder section may be releasably secured to each other in a manner that still allows relative rotation. The use of a friction reducing ring 8 between the elements further facilitates relative rotation.

A filter section 30 may be attached to a bottom end of lower section 20. The filter section 30 may include a filter 5 that has a plurality of small openings to allow small particles, such as pollen, to pass through the filter section 30, but retain larger leaf cuttings on top of the filter 5. The filter section 30 may also include a non-circular peripheral wall 38 that is dimensioned to fit into a corresponding non-circular peripheral recess (not shown in FIGS. 1 and 2) formed in the bottom end of lower section 20. As used herein, the terms “non-circular peripheral wall” and “non-circular peripheral recess” refer to at least one element on an inner or outer portion of a circumferential wall or recess that makes the inner or outer portion non-circular so as to prevent free rotation when a corresponding wall is positioned adjacent thereto. Non-circular peripheral wall 38 may include a plurality of magnetic elements 7 that are positioned to form an attractive force with corresponding magnetic elements (not shown in FIGS. 1 and 2) in the corresponding non-circular peripheral recess (not shown in FIGS. 1 and 2) of the lower section 20 to form a magnetic coupling. In an exemplary embodiment, each of the magnetic elements 7 may be, but is not limited to, a 1/10″ dia.×⅛″ thick neodymium D42 magnet. In another exemplary embodiment, some magnetic elements 7 may be a magnet, and the other magnetic elements may be a ferrous material that is attracted to magnets. Through use of the circumferentially positioned magnetic elements 7, the lower section 20 and filter section 30 of the grinder section may be releasably secured to each other in a manner that prevents relative rotation.

A collection section 40, such as for the collection of pollen, may be attached to a bottom end of filter section 30. The collection section 40 includes a closed bottom end so as to collect material that passes through filter 5, such as pollen. The collection section 40 may further include a non-circular peripheral wall 48 that is dimensioned to fit into a corresponding non-circular peripheral recess (not shown in FIGS. 1 and 2) formed in the bottom end of filter section 30. Non-circular peripheral wall 48 may include a plurality of magnetic elements 7 that are positioned to form an attractive force with corresponding magnetic elements (not shown in FIGS. 1 and 2) in the corresponding non-circular peripheral recess (not shown in FIGS. 1 and 2) of the filter section 30 to form another magnetic coupling. In an exemplary embodiment, each of the magnetic elements 7 may be, but is not limited to, a 1/10″ dia.×⅛″ thick neodymium D42 magnet. In another exemplary embodiment, some magnetic elements 7 may be a magnet, and the other magnetic elements 7 may be a ferrous material that is attracted to magnets. Through use of the circumferentially positioned (i.e., peripheral) magnetic elements 7, the filter section 30 and collection section 40 of the grinder section may be releasably secured to each other in a manner that prevents relative rotation.

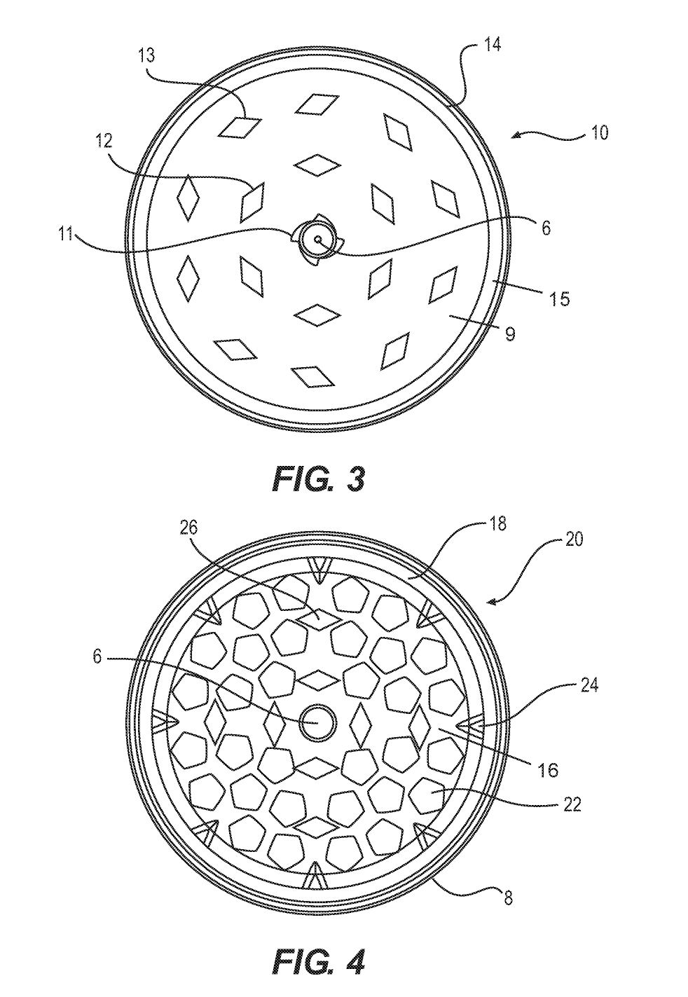

FIG. 3 illustrates a plan view from below of the upper section 10 of a grinder section according to an exemplary embodiment. As viewed from an open bottom end, upper section 10 includes a closed top end having an inner wall 9 on which a first plurality of prismatic cutting teeth 12 and 13 may be mounted at various radial and circumferential locations. While a particular number of the cutting teeth 12 and 13 are illustrated at various positions, various other configurations are possible without departing from the present inventive concepts, and the teeth themselves may take other forms such as arcs, rods, etc.

A circular peripheral wall 14 at the bottom end of upper section 10 interacts with the inner wall 9 of the upper section 10 to form an adjacent recess 15 at an inner periphery thereof. At the center of the circular peripheral wall 14, an axial magnetic element 6 may be mounted for releasably securing the upper section 10 to the lower section 20. Although centrally positioned teeth 11 may be positioned adjacent the axial magnetic element 6, these teeth 11 may alternately be positioned in a corresponding location on the lower section 20.

FIG. 4 illustrates a plan view from above of the lower section 20 of a grinder section according to an exemplary embodiment. As viewed from an open top end, the lower section 20 comprises a central wall 16 that spans across the diameter of lower section 20. The central wall 16 includes a plurality of apertures 22 for passage of cut material, such as bits of leaf or pollen, and a second plurality of prismatic cutting teeth 24 and 26 may be mounted at various radial and circumferential locations to intermesh with cutting teeth 11, 12, and 13. While a particular number of the cutting teeth 24 and 26 are illustrated at various positions, various other configurations are possible without departing from the present inventive concepts, and the teeth themselves may take other forms, such as arcs, rods, etc. In the illustrated embodiment, cutting teeth 24 are triangular projections extending inward from an outer periphery and have a different shape than cutting teeth 26.

A circular peripheral wall 18 at the top end of lower section 20 is positioned inside of and above ring 8. At the center of the circular peripheral wall 18, an axial magnetic element 6 may be mounted for releasably securing the lower section 20 to the upper section 10. In use, the circular peripheral wall 18 of lower section 20 may be dimensioned to fit in the recess 15 formed adjacent to circular peripheral wall 14 of upper section 10 and may rotate freely about the magnetic connection formed by axial magnetic elements 6 to form a grinding section. The cutting teeth 11, 12, and 13 intermesh with teeth 24 and 26 to chop leaf material into smaller pieces that are able to pass though apertures 22. While described as a lower wall and upper recess, the positions of these elements may be reversed without departing from the scope of the inventive concepts. Moreover, the circular peripheral walls 14 and 18 or their edges may be slightly tapered, chamfered, or radiused to allow easier assembly and disassembly.

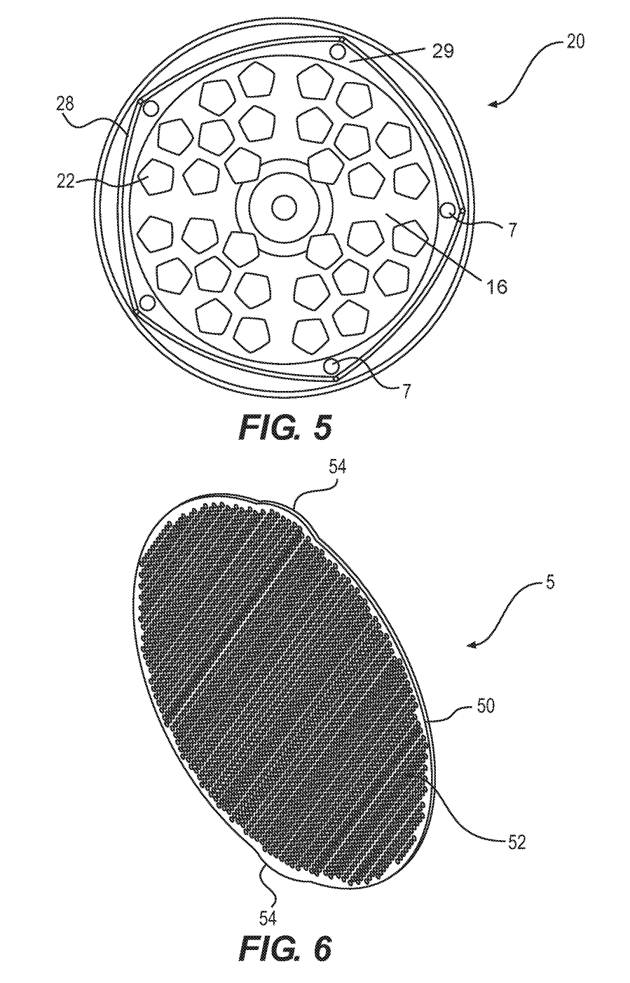

FIG. 5 illustrates a plan view from below of the lower section 20 of the grinder section according to an exemplary embodiment. As viewed from an open bottom end, the lower section 20 comprises a central wall 16 that spans across the diameter of lower section 20. The central wall 16 includes a plurality of apertures 22 for passage of cut material, such as bits of leaf or pollen. A non-circular peripheral wall 28 tapers inward down to central wall 16 to form a non-circular peripheral recess 29. A plurality of peripheral magnetic elements 7 are positioned in the non-circular peripheral recess 29. In the illustrated embodiment, five peripheral magnetic elements 7 are illustrated in a substantially pentagonal (five-sided) non-circular peripheral recess 29, but numerous other shapes and arrangements are also possible without departing from the inventive concepts.

FIG. 6 illustrates a perspective view of a filter element 5 according to an exemplary embodiment. Filter element 5 includes a thin stainless steel sheet 50 that may have a circular periphery with opposing tabs 54 extending outward. The stainless steel sheet 50 further includes a plurality of photo-etched apertures 52 dimensioned for the passage of a desirable material having a small size, such as pollen. In an exemplary embodiment, the stainless steel sheet 50 may be formed of a 0.38 mm sheet of 301 stainless steel, having 0.46 mm diameter apertures in rows 0.73 mm apart and columns 0.84 mm apart (staggered). In the illustrated embodiment, two opposing tabs 54 are illustrated on a substantially circular filter 5, but other shapes and arrangements are also possible without departing from the inventive concepts.

FIG. 7 illustrates a plan view from above of the filter section 30 according to an exemplary embodiment. As viewed from an open top end, an inner wall of the filter section 30 tapers down to a support ledge 35 that is dimensioned to support the filter 5 (not shown for clarity). Recesses 37 corresponding to the opposing tabs 54 may be formed in the inner wall of the filter section immediately above the support ledge 35. A non-circular peripheral wall 38 tapers outward down to the main portion of filter section 30. A plurality of peripheral magnetic elements 7 are positioned on a top edge of the non-circular peripheral wall 38 to correspond with peripheral magnets 7 of recess 29 (see FIG. 5). In the illustrated embodiment, five peripheral magnetic elements 7 are illustrated in a substantially pentagonal (five-sided) non-circular peripheral wall 38, but numerous other shapes and arrangements are also possible without departing from the inventive concepts.

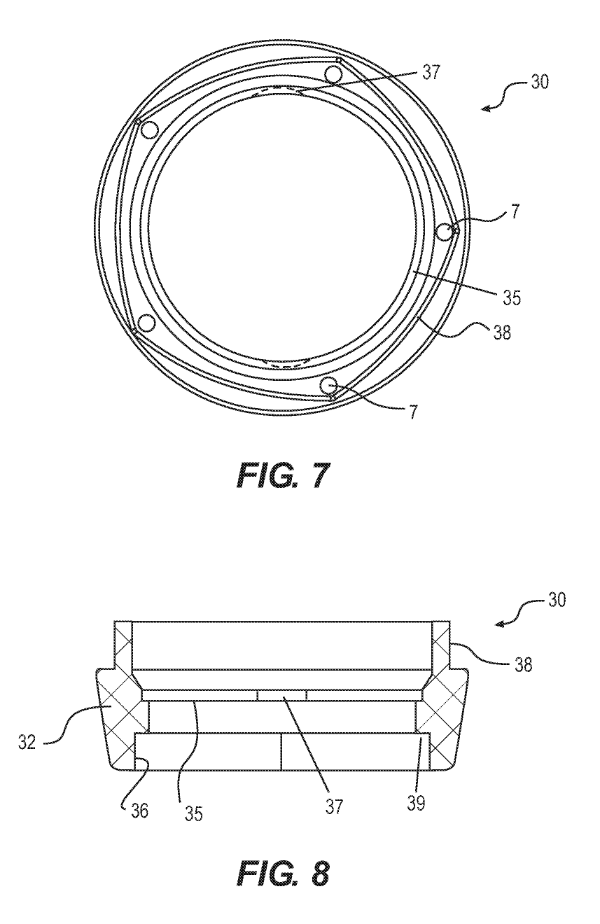

FIG. 8 illustrates a cross sectional view of the filter section 30 according to an exemplary embodiment. As disclosed above, the non-circular peripheral wall 38 extends upward from main portion 32 of filter section 30. Inner wall of the filter section 30 tapers down to a support ledge 35 that is dimensioned to support the filter 5 (not shown in position for clarity). Recesses 37 corresponding to the opposing tabs 54 may be formed in the inner wall of the filter section immediately above the support ledge 35. An open bottom end of filter section 30 includes a non-circular peripheral wall 36 forming a non-circular peripheral recess 39 adjacent thereto.

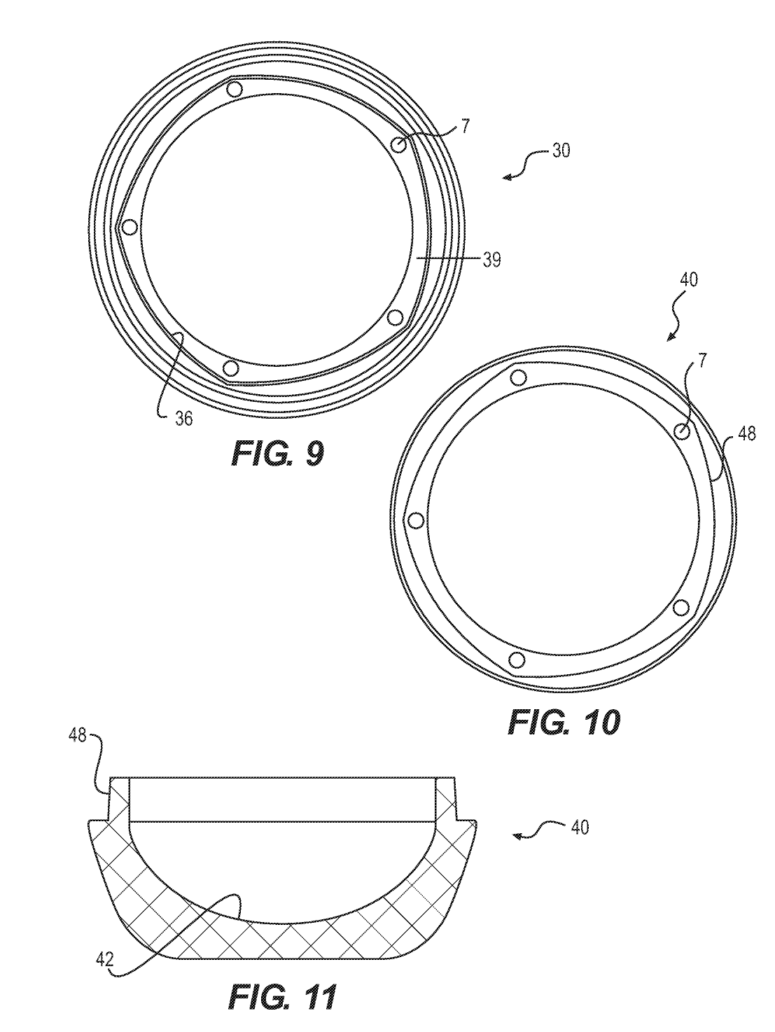

FIG. 9 illustrates a plan view from below of the filter section 30 according to an exemplary embodiment. The non-circular peripheral recess 39, as discussed above, is formed adjacent to non-circular peripheral wall 36, which preferably tapers inward. A plurality of peripheral magnetic elements 7 are positioned in the non-circular peripheral recess 39. In the illustrated embodiment, five peripheral magnetic elements 7 are illustrated in a substantially pentagonal (five-sided) non-circular peripheral recess 39, but numerous other shapes and arrangements are also possible without departing from the inventive concepts.

With respect to FIGS. 10 and 11, FIG. 10 illustrates a plan view from above of the collection section 40 according to an exemplary embodiment, and FIG. 11 illustrates a cross sectional view of the collection section 40 according to an exemplary embodiment. As viewed from an open top end in FIG. 10 and the side in FIG. 11, an inner wall of the collection section 40 tapers down to a bowl portion 42 for the collection of small diameter material, such as pollen. A non-circular peripheral wall 48 tapers outward down to the main portion of collection section 40. A plurality of peripheral magnetic elements 7 are positioned on a top edge of the non-circular peripheral wall 48 to correspond with peripheral magnets 7 of recess 39 (see FIG. 9). In the illustrated embodiment, five peripheral magnetic elements 7 are illustrated in a substantially pentagonal (five-sided) non-circular peripheral wall 48, but numerous other shapes and arrangements are also possible without departing from the inventive concepts.

In an exemplary embodiment, the sections 10, 20, 30, and 40 are made of 6061 aluminum. Holes may be formed at the positions of the magnets 6 and 7, and the magnets may be press-fit for glued into the holes for each section 10, 20, 30, and 40. The peripheral and axial magnetic elements allow easy assembly and disassembly of the multi-section herb grinder 100. Because stainless steel has a high modulus of elasticity, the photo-etched stainless steel filter 5 may be flexed upward between the opposing tabs 54 in order to be installed on support ledge 35 with tabs 54 in recesses 37 in filter section 30. Pushing the middle of the photo-etched stainless steel filter 5 from below causes similar flexing to allow removal and cleaning/service/replacement of the photo-etched stainless steel filter 5. The photo-etched stainless steel filter 5 has increased durability as compared to typical mesh filters. Further, while disclosed for use with an herb grinder, the photo-etched stainless steel filter of the present disclosure may also have utility for coffee presses, coffee filters, juicers, and the like.

Each of the non-rotating magnetic couplings for the non-rotating connections between sections 20, 30, and 40 of the multi-section herb grinder uses the same basic elements of non-circular peripheral walls and corresponding non-circular peripheral recesses that include multiple peripheral magnetic elements. While these non-rotating magnetic couplings are disclosed with respect to an herb grinder, they may also be useful in similar devices such as cheese graters, pepper mills, salt mills, juicers, presses, and the like.

Although the first and second non-circular peripheral walls are disclosed in the figures as having a substantially pentagon shape, they may comprise any non-circular shape, including but not limited to an oval, a triangle, a quadrilateral, a pentagon, a hexagon, a heptagon, an octagon, a nonagon, and a decagon. When the non-circular shape is a polygon, the peripheral magnetic elements may be disposed at apexes of the polygon. Further, as disclosed in the figures, the sides of the polygons may be curved, and are preferably curved when used with a circular cross-section device in order to save space.

In use, the upper section 10 of the grinder section is removed based on overcoming the magnetic forces between the axially positioned magnetic elements 6. The herb or other material to be ground is placed in between the teeth 26 in the lower section 20, and the upper section 10 is magnetically re-assembled to the lower section 20. The upper section 10 can then be rotated by hand to cause teeth 11, 12, and 13 to intermesh with teeth 24 and 26 to cut the material into smaller pieces. The user may hold any or all of the non-rotating sections 20, 30, and/or 40 and rotate only the upper section 10, in either direction without fear of disassembly, to cause the desired material or herb to be cut or ground into smaller pieces. Cut or ground material passes through apertures 22 into the filter section 30, and smaller material particles, such as pollen, passes through apertures 52 into the collection section 40. Cut leaf and the like can be removed from filter section 30 and pollen and the like can be removed from collection section 40 by applying a force sufficient to overcome the magnetic attraction forces between peripheral magnetic elements 7 at the desired coupling. Such force will typically be fairly light, and thus, ease operation of the device.

The use of the exemplary magnetic couplings allows for the design of attractive herb grinders, such as illustrated in FIG. 1, and also allows for easy assembly and disassembly by users.

Although certain exemplary embodiments and implementations have been described herein, other embodiments and modifications will be apparent from this description. Accordingly, the inventive concepts are not limited to such embodiments, but rather to the broader scope of the presented claims and various obvious modifications and equivalent arrangements.

What is claimed is:

1. A multi-section grinder, comprising:
a grinder section;
a filter section comprising:
an open top end;
a photo-etched stainless steel filter comprising a stainless steel sheet, a plurality of photo-etched apertures defining openings through the stainless steel sheet, and opposing tabs extending from a periphery of the stainless steel sheet; and
an open bottom end; and
a collection section comprising:
an open top end; and
a closed bottom end defining a collection bowl,
wherein each of the grinder section, the filter section, and the collection section are releasably connected to each other with a non-rotating magnetic coupling, each non-rotating magnetic coupling comprising:
a first non-circular peripheral wall on a first section comprising a first plurality of peripheral magnetic elements; and
a second non-circular peripheral wall on a second section defining a non-circular peripheral recess, wherein the non-circular peripheral recess is dimensioned to receive the first non-circular peripheral wall and comprises a second plurality of peripheral magnetic elements positioned in correspondence with the first plurality of peripheral magnetic elements to magnetically couple the first and second sections when adjacently positioned, and wherein the first and second non-circular peripheral walls prevent relative rotation between the first and second sections.

2. The multi-section grinder of claim 1, wherein:
the grinder section comprises:
an upper section comprising a closed top end, an open bottom end, a first axial magnetic element, and a first circular peripheral wall at the open bottom end; and
a lower section comprising an open top end, an axially-perforated mid-section, an open bottom end, a second axial magnetic element, and a second circular peripheral wall at the open top end configured to engage and rotate relative to the first circular wall; and
the filter section comprises:
an open top end, an open bottom end, a support ledge disposed in a central position between the open top end and the open bottom end, and opposing recesses adjacent the support ledge.

3. The multi-section grinder of claim 2, further comprising:
a first plurality of cutting teeth disposed on an inner wall of the closed top end of the upper section; and
a second plurality of cutting teeth disposed on the axially-perforated mid-section of the lower section and positioned to intermesh with the first plurality of cutting teeth in an assembled state.

4. The multi-section grinder of claim 1, wherein the first and second non-circular peripheral walls substantially comprise a polygon shape selected from the group consisting of a triangle, a quadrilateral, a pentagon, a hexagon, a heptagon, an octagon, a nonagon, and a decagon, and
wherein the first and second plurality of peripheral magnetic elements are disposed at apexes of the polygon shape.

5. The multi-section grinder of claim 1, wherein the first plurality of peripheral magnetic elements comprise neodymium magnets.

6. The multi-section grinder of claim 5, wherein the second plurality of peripheral magnetic elements comprise neodymium magnets.

7. The multi-section grinder of claim 5, wherein the second plurality of peripheral magnetic elements comprise ferrous metal subject to magnetic attraction.

8. The multi-section grinder of claim 2, wherein the first axial magnetic element comprises a neodymium magnet.

9. The multi-section grinder of claim 8, wherein the second axial magnetic element comprise a neodymium magnet.

10. The multi-section grinder of claim 8, wherein the second axial magnetic element comprise a ferrous metal subject to magnetic attraction.

11. The multi-section grinder of claim 1, wherein the stainless steel sheet comprises 301 stainless steel having a thickness of 0.38 mm, and
wherein the plurality of photo-etched apertures comprise 0.46 mm diameter apertures in rows 0.73 mm apart and columns 0.84 mm apart.

12. A non-rotating magnetic coupling for attaching open ends of first and second sections of a generally tubular device, comprising:
a first non-circular peripheral wall on the first section comprising a first plurality of peripheral magnetic elements; and
a second non-circular peripheral wall on the second section defining a non-circular peripheral recess,
wherein the non-circular peripheral recess is dimensioned to receive the first non-circular peripheral wall and comprises a second plurality of peripheral magnetic elements positioned in correspondence with the first plurality of peripheral magnetic elements to magnetically couple the first and second sections when adjacently positioned, and
wherein the first and second non-circular peripheral walls prevent relative rotation between the first and second sections.

13. The non-rotating magnetic coupling of claim 12, wherein the first plurality of peripheral magnetic elements comprise neodymium magnets.

14. The non-rotating magnetic coupling of claim 13, wherein the second plurality of peripheral magnetic elements comprise neodymium magnets.

15. The non-rotating magnetic coupling of claim 13, wherein the second plurality of peripheral magnetic elements comprise ferrous metal subject to magnetic attraction.

16. The non-rotating magnetic coupling of claim 12, wherein the first and second non-circular peripheral walls substantially comprise a non-circular shape selected from the group consisting of an oval, a triangle, a quadrilateral, a pentagon, a hexagon, a heptagon, an octagon, a nonagon, and a decagon.

17. The non-rotating magnetic coupling of claim 16, wherein the non-circular shape substantially comprises a polygon and the first and second plurality of peripheral magnetic elements are disposed at apexes of the polygon.

18. A photo-etched stainless steel filter, comprising:
a stainless steel sheet;
a plurality of photo-etched apertures defining openings through the stainless steel sheet; and
opposing tabs extending from a periphery of the stainless steel sheet.

19. The photo-etched stainless steel filter of claim 18, wherein the stainless steel sheet comprises 301 stainless steel having a thickness of 0.38 mm.

20. The photo-etched stainless steel filter of claim 18, wherein the plurality of photo-etched apertures comprise 0.46 mm diameter apertures in rows 0.73 mm apart and columns 0.84 mm apart.
